(19) United States
(12) Patent Application Publication
(10) Pub. No.: US 2011/0045861 A1
(43) Pub. Date: Feb. 24, 2011

(54) METHOD FOR COMMUNICATION BETWEEN A BASE STATION AND A PLURALITY OF TRANSPONDERS

(76) Inventor: Ulrich FRIEDRICH, Ellhofen (DE)

Correspondence Address: Muncy, Geissler, Olds & Lowe, PLLC, 4000 Legato Road, Suite 310, FAIRFAX, VA, 22033, US

(21) Appl. No.: 12/860,254

(22) Filed: Aug. 20, 2010

Related U.S. Application Data
(60) Provisional application No. 61/235,541, filed on Aug. 20, 2009.

(30) Foreign Application Priority Data
Aug. 20, 2009 (DE) 10 2009 037 998.3

(51) Int. Cl. H04B 7/00

(52) U.S. Cl. 455/509

(57) ABSTRACT

A method for communication between a base station and a plurality of transponders, whereby a group with at least two transponders is selected by the base station from among a plurality of transponders and a first transponder is selected from the group of transponders, whereby a session to exchange data is arranged with the first transponder, and whereby the session has a starting time and an ending time, and data are exchanged with the first transponder during the session and a second transponder of the group is selected by the base station during the session with the first transponder and a session is arranged with the second transponder.

This nonprovisional application claims priority to German Patent Application No. DE 102009037998.3, which was filed in Germany on Aug. 20, 2009, and to U.S. Provisional Application No. 61/235,541, which was filed on Aug. 20, 2009, and which are both herein incorporated by reference.

### BACKGROUND OF THE INVENTION

1. Field of the Invention

The present invention relates to a method for communication between a base station and a plurality of transponders.

2. Description of the Background Art

A method for communication with a base station and a plurality of transponders is known, for example, from the ISO standard 18000-6C, version dated 1 Jul. 2005. For example, on page 35 of the standard, a group of transponders is selected from a plurality of transponders by means of a selection process with use of select commands, and a session with an individual transponder from the selected group is arranged by means of a subsequent process, the so-called inventory process. After this, within the arranged session, during the so-called access process, data are exchanged between the base station and the selected transponder. Further, different types of sessions can be arranged with the transponders selected in such a way by setting of status bits. After a session or a certain type of session has ended, a session can likewise be arranged with another transponder.

Transponders are used, inter alia, for detecting or identifying products and the properties thereof. In this respect, the transponders are placed on individual products, which may be arranged on a stack or on a pallet. To increase the effectiveness and to reduce costs, it is important to detect a plurality of transponders or products as quickly as possible by a base station and to process the read data. A plurality of base stations, for example, is also used for this purpose. The individual base stations are connected for this purpose to a so-called host computer. In general, for reasons of cost, passive transponders are used for the most part for labeling products. Transponders of this type draw power by means of absorption modulation from the energy of the carrier wave transmitted by the base station. To increase the communication range, it is advantageous to keep the power consumption low, for example, by reducing the transponder clock speed. As a result, however, the communication speed between the base station and the transponders declines.

### SUMMARY OF THE INVENTION

It is therefore an object of the present invention is to improve the state of the art as much as possible and to provide a suitable method for this purpose.

According to an embodiment of the invention, a method is provided for communication between a base station and a plurality of transponders, whereby a group with at least two transponders is selected by the base station from among the plurality of transponders and a first transponder is selected from the group of transponders, a session to exchange data is arranged with the first transponder, and whereby the session has a starting time and an ending time and data are exchanged with the first transponder during the session and a second transponder of the group is selected by the base station during the session with the first transponder and a session is arranged with the second transponder.

An advantage of the method of the invention is that substantially more transponders are detected per unit time by the communication or the arrangement of a number of sessions by the base station with a plurality of transponders. Waiting times of the base station, which are determined, for example, by the reduction of the clock speed within the transponder to assure the transponder's power supply, are utilized hereby by setting up at least one additional session during an existing session.

In an embodiment, data are exchanged by the base station with the second transponder during the arranged session. Inter alia, the electronic product code of the particular transponder is transmitted to the base station during a session.

Tests by the applicant have shown that it is advantageous when the session with the second transponder is arranged during an authentication routine of the first transponder. In particular, longer base station waiting times occur until the transponder sends back the necessary responses during the authentication routine, which is due to the increased security requirements for data encryption and the computing power necessary for this in the transponder, particularly in the case of clock speed reduction. Further, waiting times also result when the base station exchanges or matches data with a so-called host computer and the communication with the transponder within an existing session continues only after the data exchange. The method of the invention makes it possible to reduce such waiting times.

In another embodiment, the session with the second transponder is arranged during an encrypted read access to the memory area of the first transponder. Here as well, increased waiting times often occur in the case of the base station until the transponder sends the encrypted data back to the base station.

Further, according to another embodiment, it is advantageous to arrange sessions in part parallel in time with a majority of transponders, preferably more than two, and most preferably with a plurality of transponders comprising a number greater than five transponders. This increases the effectiveness of the method further.

According to the aforementioned standard, at least two types of sessions can be differentiated. In a first type of session, inter alia, an authentication routine is performed by the base station with the transponder, and in a second type of session, an encrypted read access by the base station to memory areas of the selected transponders is carried out by means of the key agreed upon in the first session. Tests by the applicant have shown that the detection rate of the transponder by the base station can be increased further, when different types of sessions are set up in part parallel in time; i.e., the base station arranges a second type of session with another transponder during the period in which a first type of session was arranged with a transponder.

Further, the method can also be used advantageously when the response time in a transponder is unusually long or even leads to a premature abort, for example, due to lack of power. Long waiting times, which occur in a sequential session arrangement of the base station with the transponders selected within a group, are substantially reduced by the method of the invention. Further, transponders that recently enter the field of the base station and meet the group selection criterion can be detected even during an ongoing session and optionally read out.

Tests by the applicant have shown that the method of the invention can be carried out advantageously in passive transponders, i.e., in transponders that during a session draw power by means of an absorption modulation from the carrier field of the base station and carry out the communication in particular with the base station by means of modulated backscatter of the carrier wave sent out by the base station. This encompasses primarily UHF transponders, operated within a frequency range above 500 MHz. Further, the method can be carried out especially advantageously in inductively, i.e., transformer-like, coupled LF transponders, which operate preferably at 125 KHz and most preferably at 13.56 MHz. LF transponders of this type generally have a low data rate and accordingly long communication times.

In a use, the method of the invention can be used to increase the detection speed of a plurality of transponders in an inventory control system.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1a shows a base station and with a plurality of transponders in the field of the base station;

FIG. 1b shows a sequential order of sessions according to the state of the art;

FIG. 2 shows a schematic embodiment of the method of the invention;

FIG. 3a shows a detailed embodiment of the method of the invention for a first type of session;

FIG. 3b shows a detailed embodiment of the method of the invention for a second type of session; and

FIG. 4 shows a schematically depicted use of the method of the invention with a majority of base stations.

### DETAILED DESCRIPTION

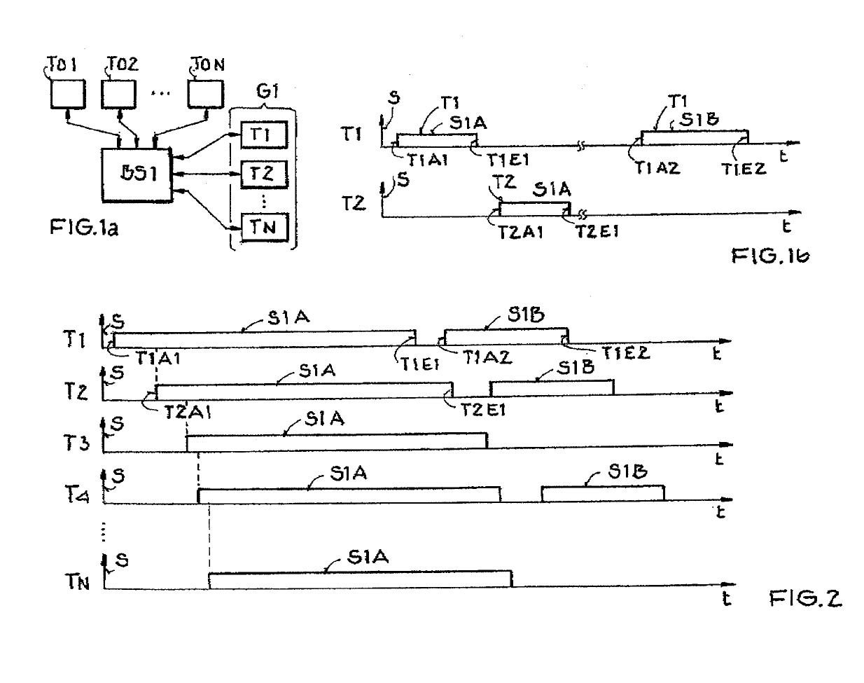

The illustration in FIG. 1 shows a base station BS1 with a plurality of transponders T1, T2 to TN and T01, T02 to T0N in the field of the base station BS1. In this regard, the transponders T1, T2 to TN are selected as a group G1 by the base station.

The illustration in FIG. 1b shows a sequential arrangement of sessions of the base station BS1 with the selected transponders T1 and T2 according to the prior art. A signal S is plotted schematically over a time t. A first type of session S1A is arranged by the base station BS1 with the transponder T1. The first type of session S1A has a starting time T1A1 and an ending time T1E1. After the end of the session S1A, the base station BS1 arranges with transponder T2 a first type of session S1A with a starting time T2A2 and an ending time T2E1. After the end of the first session with transponder T2, base station BS1 arranges a second type of session S1B with transponder T1 with a starting time TIA2 and an ending time T1E2. Within the individual types of sessions, data are exchanged between transponder T1 or transponder T2 and base station BS1. It is evident from the figures that to gather the transponder data from all transponders in a group, addition of the individual required session time periods is necessary.

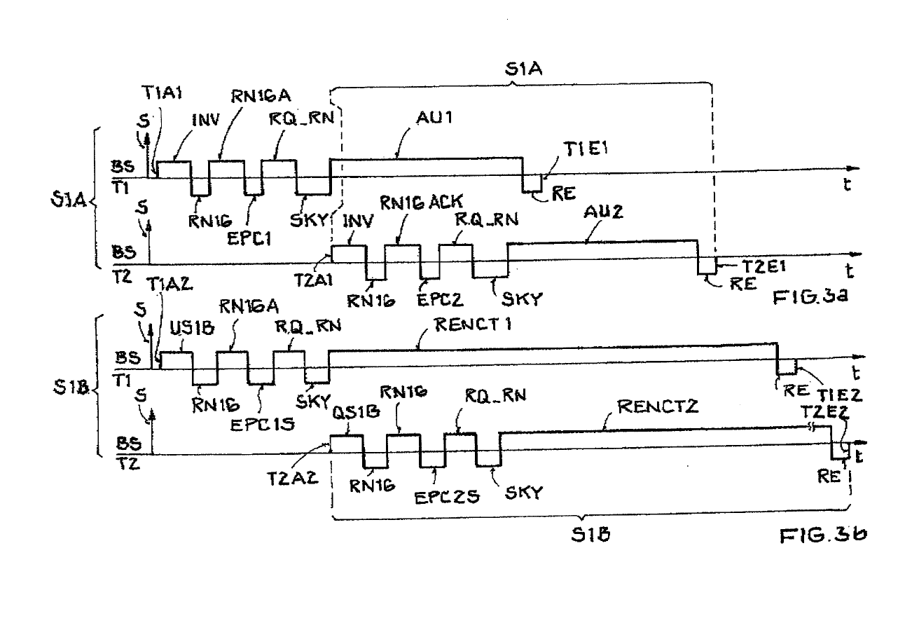

An embodiment of the method of the invention is shown schematically in the illustration in FIG. 2. Only the differences to the statements provided in relation to the explanations for drawing documents of FIG. 1b will be set forth below. Accordingly, during the ongoing first type of session S1A, a likewise first type of session S1A is arranged by base station BS1 with transponder T2. Further, the first type of session S1A is arranged and data are exchanged in each case with a transponder T3, a transponder T4, and finally with a transponder TN, while the first type of the session of transponder T1 continues. In this regard, the first type of session of transponders T1, T2, T3, T4, and TN still continues, while the base station already arranges the second type of session with transponder T1. While the second type of session S1B with transponder T1 continues, the base station also arranges the second type of session S1B with transponder T2 and transponder T4.

The time length of the individual first type and the individual second type of sessions is shown arbitrarily and can vary considerably from session to session. The exchange of data in sessions set up parallel between the particular transponders and the base station occurs preferably in such a way that the data exchange by the selected transponders with the base station does not overlap. The possible number of sessions arranged in part parallel in time depends on the conditions of the communication and the speed of the communication between the transponders and the base station. The more rapid the communication between a transponder and a base station, the fewer parallel sessions are arranged by the base station.

A detailed exemplary embodiment of the communication structure between base station BS1 and transponder T1 and transponder T2 within the first type of session S1A and within the second type of session S1B is shown in the illustration in FIGS. 3a and 3b. The set-up of the communication is shown in a greatly simplified form. The time periods of the individual session intervals S1A or S1B in particular and the individual communication intervals within the shown session intervals are depicted arbitrarily and can vary greatly. The communication from base station BS1 to transponder T1 or to transponder T2 is shown above the t-axis. The communication of transponder T1 or of transponder T2 to base station BS1 is shown below the t-axis. At the time T1A1, base station BS1 arranges the first type of session S1A with transponder T1 by means of a command INV, whereupon the transponder sends back a datum RN16 and base station BS1 sends a datum RN16A back to transponder T1. Transponder T1 then sends the product code EPC1, whereupon base station BS1 sends the datum RQ_RN and transponder T1 the datum SKY. Thereupon, base station BS1 begins with a datum AU1 and receives the datum RE back from transponder T1. Next, the first type of session S1A is ended. During the datum AU1, which is formed, for example, as an authentication sequence, a considerable amount of data is generated within base station BS1. In the meantime, base station BS1 likewise arranges a first type of session S1A with transponder T2 and receives inter alia in a parallel session the electronic product code EPC2 of transponder T2 sent as datum EPC2.

A second type of session S1B is shown in the illustration in FIG. 3b. Only the differences to the statements in relation to the explanations for drawing documents of FIG. 3a will be set forth below. Accordingly, in the session transponder T1 sends back the datum EPC1S. During the datum RENCT2, which is formed, for example, as an encrypted read access, a considerable amount of data is generated within base station BS1. In the meantime, base station BS1 likewise arranges session S1B with transponder T2 and receives inter alia a response in a parallel session returned as the datum EPC2S.

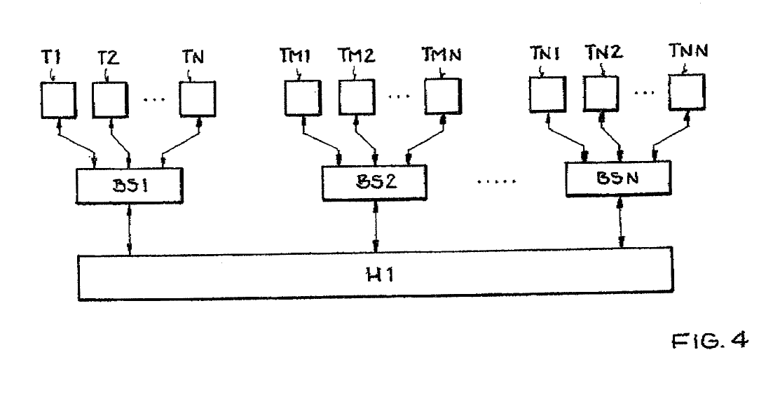

Apart from base station BS1 that communicates with transponder T1, with transponder T2 to transponder TN, and a host computer H1, a base station BS2 that communicates with a transponder TM1, with a transponder TM2 to a transponder TMN, and with the host computer H1, and a base station BS3 that communicates with a transponder TN1 and a transponder TN2 and a transponder TNN and the host computer H1 are shown in the illustration in FIG. 4. Because the base stations exchange data with the host computer during the sessions, apart from the calculations to be performed within the base station, other delays in the speed of the communication occur within a session between the transponder and the base station. It is therefore especially advantageous to use the method of the invention in an arrangement consisting of a plurality of base stations. In this way, by means of the parallelization of sessions a considerable saving of time during the gathering of the transponder data is achieved.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A method for communicating between a base station and a plurality of transponders, the method comprising:
selecting, via the base station, a group with at least two transponders from among the plurality of transponders;
selects a first transponder from the group of transponders;
arranges a session with the first transponder to exchange data, the session having a starting time and an ending time; and
exchanging data with the first transponder during the session
wherein a second transponder of the group is selected by the base station during the session with the first transponder and a session is arranged with the second transponder.

2. The method according to claim 1, wherein data are exchanged between the base station and the second transponder.

3. The method according to claim 1, wherein an electronic product code is transmitted to the base station by the transponders during the session.

4. The method according to claim 1, wherein the session with the second transponder is arranged during an authentication routine of the first transponder.

5. The method according to claim 1, wherein the session with the second transponder is arranged during an encrypted read access to a memory area of the first transponder.

6. The method according to claim 1, wherein a plurality of sessions are set up in part parallel in time.

7. The method according to claim 1, wherein different types of sessions are set up parallel.

8. The method according to claim 1, wherein power supply is carried out by the transponders during the sessions via backscattering from the carrier field of the base station.

9. The method according to claim 1, wherein a detection speed of a plurality of transponders in an inventory control system is increased.

10. A use of the method according to claim 1, for transponders that have a transformer-like coupling to the carrier field of the base station.

11. A use of the method according to claim 1, for transponders that carry out the communication with the base station by means of modulated backscatter of the carrier wave sent out by the base station.
